(19) United States
(12) Patent Application Publication
(10) Pub. No.: US 2025/0363460 A1
(43) Pub. Date: Nov. 27, 2025

(54) SYSTEMS AND METHODS FOR ELECTRONIC DATA MANAGEMENT AND VISUALIZATION

(71) Applicant: Lee Labs, LLC, San Francisco, CA (US)

(72) Inventors: Albert LEE, Hillsborough, CA (US); Michael LEE, San Francisco, CA (US); Nicholas LAU, San Francisco, CA (US); Warren WAN, Pasadena, CA (US); Emily HOM-NICI, Brooklyn, NY (US); Ben MCALLISTER, Chapel Hill, NC (US)

(21) Appl. No.: 18/671,255

(22) Filed: May 22, 2024

(51) Int. Cl. G06Q 10/1093

(52) U.S. Cl. CPC G06Q 10/1093

(57) ABSTRACT

Systems and methods of managing an event on a data organizer application are disclosed. One method may include: detecting an event associated with an electronic data organizer of a user; presenting a control menu associated with the event, the control menu comprising an event attendance toggle; receiving input directed to the event attendance toggle; assigning, based on the received input, the event to a first layer or a second layer of the electronic data organizer, wherein events in the first layer are positioned in front of events in the second layer; designating an availability state of the user for a duration of the event, wherein the availability state corresponds to an available state or an unavailable state; displaying the event in the first layer or the second layer based on the received input; and broadcasting the availability state of the user to at least one other user.

### TECHNICAL FIELD

The present disclosure relates generally to the field of data analytics, management, and visualization and, more particularly, to systems and methods for managing multiple electronic data organization tools and enhancing the prioritization and display of related data.

### BACKGROUND

The prevalence of electronic data organization tools in modern society, such as electronic calendars, has transformed the way that individuals manage their time and commitments. However, the existing landscape of calendar systems present a number of inherent challenges, especially as individuals navigate between multiple calendars for work, personal, and family obligations. For instance, some common issues include: the inconvenience of checking multiple calendars, the trade-off between information visibility and clarity, incomplete representations of commitments, and the static nature of calendar views. In view of the foregoing, traditional electronic calendars generally lack the precision and adaptability needed to seamlessly integrate various commitments, which often results in fragmented scheduling and potential oversights.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are provided for optimized data visualization within calendar systems.

In one aspect, a computer-implemented method for managing an event on a data organizer application is provided. The computer-implemented method may include: detecting, using a processor associated with the data organization application, an event associated with an electronic data organizer of a user; presenting, using the processor and on the data organizer application, a control menu associated with the event, the control menu comprising an event attendance toggle; receiving, from the user, input directed to the event attendance toggle; assigning, using the processor and based on the received input, the event to a first layer or a second layer of the electronic data organizer, wherein events in the first layer are positioned in front of events in the second layer; designating, using the processor and based on the received input, an availability state of the user for a duration of the event, wherein the availability state corresponds to an available state or an unavailable state; displaying, using the processor and on the electronic data organizer, the event in the first layer or the second layer based on the received input; and broadcasting, using the processor, the availability state of the user to at least one other user of the data organizer application.

In another aspect, a computer system for managing an event on a data organizer application is provided. The computer system may include: at least one processor; at least one memory storing instructions that are executable by the at least one processor, wherein the instructions cause the at least one processor to: detect a new event associated with an electronic data organizer of a user; present, on the data organizer application, a control menu associated with the event, the control menu comprising an event attendance toggle; receive, from the user, input directed to the event attendance toggle; assign, based on the received input, the event to a first layer or a second layer of the electronic data organizer, wherein events in the first layer are positioned in front of events in the second layer; designate, based on the received input, an availability state of the user for a duration of the event, wherein the availability state corresponds to an available state or an unavailable state; display, on the electronic data organizer, the event in the first layer or the second layer based on the received input; and broadcast the availability state of the user to at least one other user of the data organizer application.

In yet another aspect, a non-transitory computer-readable medium storing computer-executable instructions is provided. The computer-executable instructions, when executed by at least one processor, cause the at least one processor to perform operations including: detecting an event associated with an electronic data organizer of a user; presenting, on the data organizer application, a control menu associated with the event, the control menu comprising an event attendance toggle; receiving, from the user, input directed to the event attendance toggle; assigning, based on the received input, the event to a first layer or a second layer of the electronic data organizer, wherein events in the first layer are positioned in front of events in the second layer; designating, based on the received input, an availability state of the user for a duration of the event, wherein the availability state corresponds to an available state or an unavailable state; displaying, on the electronic data organizer, the event in the first layer or the second layer based on the received input; and broadcasting the availability state of the user to at least one other user of the data organizer application.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of any embodiment will be pointed out in the appended claims.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system infrastructure for executing the techniques described herein, according to one or more embodiments of the present disclosure.

FIG. 2 depicts an exemplary calendar configured to leverage certain “layers” features, according to one or more embodiments of the present disclosure.

FIGS. 3A and 3B depict exemplary selection states of an availability control, according to one or more embodiments of the present disclosure.

FIGS. 4A and 4B depict additional exemplary states of an availability control, according to one or more embodiments of the present disclosure.

FIGS. 5A and 5B depict additional exemplary states of an availability control, according to one or more embodiments of the present disclosure.

FIG. 6 depicts a process for implementing a selection on an availability control, according to one or more embodiments of the present disclosure.

FIG. 7 depicts an exemplary option flow for responding to an RSVP event, according to one or more embodiments of the present disclosure.

FIGS. 8A and 8B depict exemplary selections associated with a shared calendar, according to one or more embodiments of the present disclosure.

FIG. 9 depicts an exemplary event scheduler popup, according to one or more embodiments of the present disclosure.

FIG. 10 depicts an exemplary calendar overview, according to one or more embodiments of the present disclosure.

FIG. 11 depicts an exemplary event scheduler, according to one or more embodiments of the present disclosure.

FIG. 12 depicts an exemplary event preview screen, according to one or more embodiments of the present disclosure.

FIG. 13 depicts an exemplary tag bar, according to one or more embodiments of the present disclosure.

FIG. 14 depicts an exemplary calendar interface, according to one or more embodiments of the present disclosure.

FIG. 15 depicts an exemplary calendar interface, according to one or more embodiments of the present disclosure.

FIG. 16 depicts an exemplary calendar interface, according to one or more embodiments of the present disclosure.

FIG. 17 depicts an exemplary multi-calendar overview screen, according to one or more embodiments of the present disclosure.

FIG. 18 depicts an exemplary lens interface, according to one or more embodiments of the present disclosure.

FIG. 19 depicts an exemplary theme selection preview, according to one or more embodiments of the present disclosure.

FIGS. 20A to 20D depict an exemplary search interfaces, according to one or more embodiments of the present disclosure.

FIG. 21 depicts an exemplary rule designation interface for assigning a tag to an event, according to one or more embodiments of the present disclosure.

FIG. 22 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “about,” and “generally,” are used to indicate a possible variation of ±10% of a stated or understood value.

As used herein, the term “information handling device” generally encompasses virtually any type of electronic computing device including, for example, laptop and/or personal computers, smart phones, tablet devices, wearable devices, hybrid devices, other types of user devices, and the like. The term “information handling device” may be used interchangeably with, or in place of, any or all of the aforementioned types of computing devices. Additionally, utilization of one of the foregoing terms over another may not be intended to be limiting unless explicitly designated as such.

In contemporary society, the reliance on data organization tools, such as electronic calendars, has become indispensable for managing time and commitments. However, a universal challenge persists as individuals contend with the complexity of juggling multiple calendars and/or single calendars that are filled with an overabundance of information. Conventional calendar systems, while widely adopted, are inherently limited in their ability to seamlessly integrate disparate commitments and to intelligently manage the volume and types of information that are displayed, thereby leading to inefficiencies in time management and attention allocation.

One conventional issue that many individuals encounter is the inconvenience of consulting multiple calendars to acquire the total information they need. More particularly, conventional electronic calendars often segregate commitments into different calendars, such as ones related to work, personal matters, and family. This separation makes it challenging for individuals to obtain a holistic view of their schedule and may also lead to potential oversights. In a similar vein, managing commitments across different calendars often involves manual effort (e.g., an individual may need to manually duplicate an event on multiple calendars to ensure accurate representation of their availability), which may be time-consuming, burdensome, and prone to errors. As another issue, conventional calendars primarily focus on events with specific time constraints, neglecting tasks and commitments that are not tied to a particular time. This results in an incomplete view of an individual's total commitments, with the risk of neglecting important tasks in favor of urgent, time-bound events. Furthermore, in yet another example issue, contemporary electronic calendars generally mimic traditional paper calendars, lacking the adaptability needed for diverse scheduling needs. Specifically, users are often confined to static views that may not align with the dynamic nature of their tasks, whether it be planning a work week or organizing a vacation.

The present disclosure is accordingly directed to systems and methods that redefine the technical landscape of electronic calendars by introducing a dynamic and integrated event prioritization and presentation system. The present disclosure provides a novel approach that optimizes data visualization within a calendar application. This approach enables users to dynamically organize and display calendar data based on various user-defined metrics, as further described herein. By providing flexible views and an integrated task management features, the concepts described herein deliver a unified and efficient solution to the challenges posed by conventional electronic calendars.

The methods and systems described herein represent a variety of technical improvements to computer technology, in the field of data analytics, data management, and data visualization. For example, the introduction of layered event viewing (e.g., through implementation of event prioritization along a digital “z-axis”) represents a fundamental shift in how events are organized and presented in electronic calendars. More particularly, through the embodiments associated with the “layers” concept described herein, events from multiple calendars may be co-displayed on a single screen, thereby negating a need for a user to utilize multiple computing devices, and/or multiple applications on computing devices, to view the entirety of their relevant calendar data. Furthermore, layered event viewing leverages an additional digital dimension that conventional calendars had not previously utilized, thereby enabling the concepts described herein to present more information to a user, in a clearer way, and all while occupying less digital real estate. Furthermore, novel visualization techniques, such as color-coded tags and customizable themes, contribute to an improved user interface, which may enhance a user's interaction with the computer system.

Additionally to the foregoing, the rule-based tagging and the advanced search functionalities described herein go beyond basic organizational concepts. Specifically, the ability to automatically apply tags based on search criteria involves a technical approach to event management that has not been conventionally explored. Additionally, the dynamic assignments of tags based on user behavior or automated analysis contributes to an intelligent and user-friendly system that adapts to user preferences over time. Furthermore, the customization capabilities introduced by the “lenses” concept,” e.g., the ability to save and apply rulesets for displaying events in different contexts, may represent a technical solution that improves user customization as well as customized visualization capabilities. All of the foregoing enhancements and customization options to a calendar-based user interface may represent technical solutions to real-world problems.

Furthermore, the dynamic nature by which various graphical user interface (GUI) icons and/or visual elements associated with the electronic calendar are represented may exemplify a specific improvement over conventional systems. Specifically, the position and/or visual appearance of various icons and/or elements of the electronic calendar may be automatically adjusted based on identified user preference data (e.g., deduced from prior user inputs to a calendaring application, dynamically determined from user interactions with other applications, dynamically determined from data received from other applications, etc.) and/or other types of context data associated with a user. These dynamic GUI adjustments require the user of a processor and cannot be practically applied in the human mind. Additionally, these unique GUI traits result in an improved user interface for electronic devices that implement the electronic calendar.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

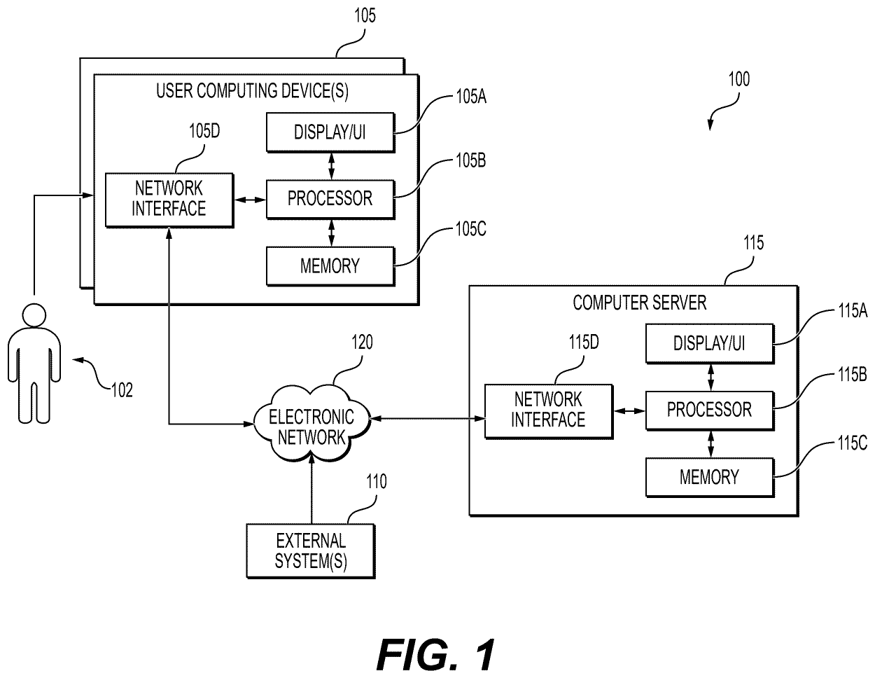

FIG. 1 depicts an exemplary system environment 100 for event visualization that may be utilized with techniques presented herein. A user computing device 105, an external system(s) 110, and a computer server 115 may communicate across a network 120. The user computing device 105 may be associated with a user 102, e.g., a user that interacts with one or more of their electronic data organizers (also referred to herein as calendars, electronic calendars, or the like). The external system(s) 110 may be associated with one or more entities that may store and/or communicate data relevant to the user. For example, the external system(s) 110 may be another email or communication platform, a social media platform, another data store containing other types of user information, and the like.

The user computing device 105, the external system 110, and the computer server 115 may be connected via network 120, e.g., using one or more standard communication protocols. The network 120 may comprise one or more networks that connect devices and/or components of system environment 100 to allow communication between the devices and/or components. For example, the network 120 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of environment 100. In some embodiments, the network 120 may be implemented using cell and/or pager networks, satellite, licensed radio, or a combination of licensed and unlicensed radio. The network 120 may be associated with a cloud platform that stores data and information related to methods disclosed herein.

In some embodiments, network 125 includes the Internet, and information and data provided between various systems occurs online. “Online” may refer to connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As shown in FIG. 1, the computer server 115 may be in communication with the user computing device 105 to transmit and receive messages, instructions, and/or other data from each other across the network 120. The user computing device 105 may be associated with a user that is utilizing a data organizer application, such as an email and/or calendaring application, provided by the computer server 115. The computer server 115 may be configured to receive data over the network 120 from the user computing device 105, e.g., new event creations, even modifications, responses to event requests, calendar settings adjustments, etc., and from external system(s) 110, e.g., context data associated with the user such as user availability, user location, user preferences, etc. In some embodiments, the computer server 115 may be a server cluster, or any other collection or network of a plurality of computer servers.

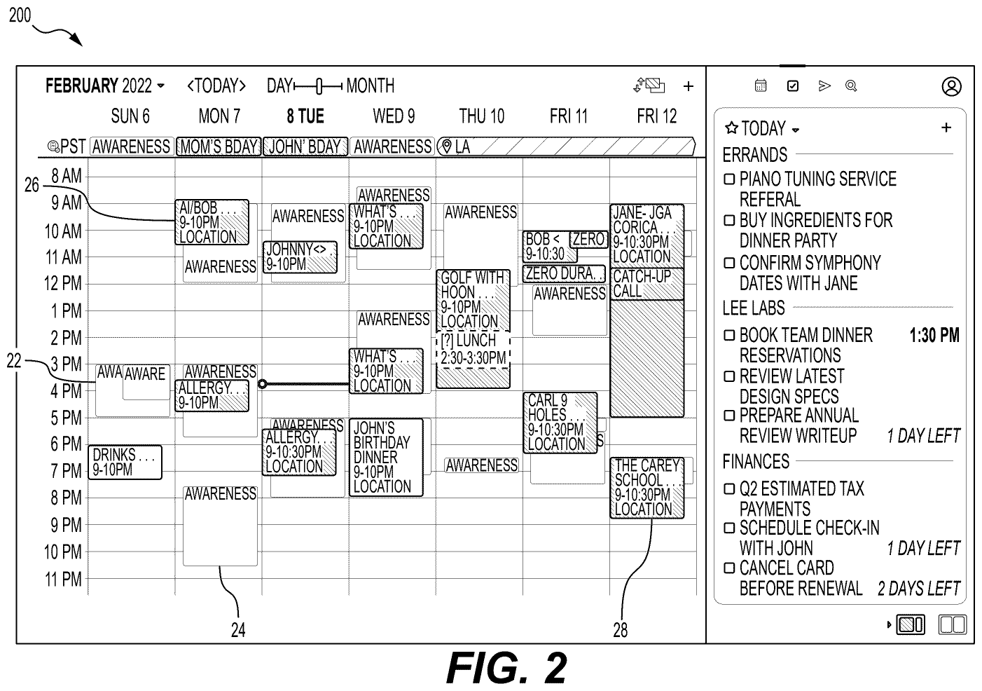

The user computing device 105 may include a display/user interface (UI) 105A, a processor 105B, a memory 105C, and/or a network interface 105D. The user computing device 105 may be a personal computer (PC), a tablet PC, a streaming device, a smart TV, a gaming console, a personal digital assistant (PDA), a mobile device, a palmtop computer, a laptop computer, a desktop computer, or any other information handling device capable of accessing and utilizing features of a calendaring application as described herein. The user computing device 105 may execute, by the processor 105B, an operating system (O/S) and at least one application (each stored in memory 105C). The application may be a browser program or a mobile application program (which may also be a browser program in a mobile O/S). The application may generate one or more interactive graphic user interfaces (GUIs) and/or graphical elements, such as, for example, the exemplary GUIs and elements shown in FIGS. 2-20, based on instructions/information received from the server 115. In some embodiments, the application may generate one or more interactive GUIs based on instructions/information stored in the memory 105C. The interactive GUIs may be application GUIs for the application executed based on XML and Android programming languages or Objective-C/Swift, but one skilled in the art would recognize that this may be accomplished by other methods, such as webpages executed based on HTML, CSS, and/or scripts, such as JavaScript. The display/UI 105A may be a touch screen or a display with other input systems (e.g., mouse, keyboard, etc.). The network interface 105D may be a TCP/IP network interface for, e.g., Ethernet or wireless communications with the network 120. The processor 105B, while executing the application, may receive user inputs from the display/UI 105A, and perform actions or functions in accordance with the application.

External system(s) 110 may be, for example, one or more third-party and/or auxiliary systems that integrate and/or communicate with the server systems 115, 120 in performing various user access control tasks. For example, the external system(s) may include an identity provider that may be configured to validate user login credentials (e.g., by comparison of the user login credentials to a credential database 110A) and issue identity (ID) tokens, as further described herein. External systems 110 may be in communication with other device(s) or system(s) in the environment 100 over the one or more networks 120. For example, external system(s) 110 may communicate with the authorization server 115 via API (application programming interface) access over the one or more networks 120, and may also communicate with the user device(s) 105 via web browser access over the one or more networks 120.

The computer server 115 may include a display/UI 115A, a processor 115B, a memory 115C, and/or a network interface 115D. The server 115 may be a computer, system of computers (e.g., rack server(s)), and/or or a cloud service computer system. The server 115 may execute, by the processor 115B, an operating system (O/S) and at least one instance of a server program (each stored in memory 115C). The server 115 may store or have access to information from external system(s) 120. The display/UI 115A may be a touch screen or a display with other input systems (e.g., mouse, keyboard, etc.) for an operator of the server 115 to control the functions of the server 115 (e.g., update the server program and/or the server information). The network interface 115D may be a TCP/IP network interface for, e.g., Ethernet or wireless communications with the network 120. Computer server 115 may store data associated with user 102 of user computing device 105. For instance, computer server 115 may store contact information for other individuals user 102 is associated with, settings data for one or more calendars used by user 102, event data associated with the one or more calendars, and the like. Additionally or alternatively, computer server 115 may store additional data received from user computing device 105 including real time and/or near real time location data (e.g., GPS data) of the user computing device 105.

### Layering

Conventional digital calendars offer solutions to manage events. However, they fall short in providing a unified and intuitive approach to handle commitments across various calendars. For instance, conventional calendars focus on individual calendars, leading to a fragmented display of availability information. For example, a user's work calendar may not be aware of events on their personal calendar, causing discrepancies in availability representation. Additionally, combining multiple calendars in a single view often results in information overload. In these situations, users must navigate through a cluttered interface, making it challenging to prioritize essential commitments.

To address some or all of the foregoing issues, this section introduces a concept referred to as “layers,” which encompass layered event display and multi-account calendar management. The layers allow users to view multiple calendars simultaneously without sacrificing clarity. They establish a visual hierarchy by presenting foregoing commitments distinctly, while background events provide informational context. Additionally, the utilization of layers enables prioritization of a user's true availability across various calendars. More particularly, it addresses the challenge of calendars being “self-centered” and ensures that an individual's actual availability is accurately represented. Furthermore, a novel availability control is also contemplated, which helps differentiate commitments from informational events. This control, applied consistently across event types, may simplify the manipulation of layers for personal and work events. Additionally still, through dynamic layer manipulation, users may independently manipulate attributes such as attendance, attention, and availability for each event. This feature ensures that users can customize their calendar experience and visibility according to their preferences. Additionally still, users may utilize layers to address challenges specific to family calendars, e.g., where events are shared among multiple users.

Referring now to FIG. 2, an exemplary calendar 200 configured to leverage the foregoing types of “layering” features is presented herein. Calendar 200 may be configured to function in accordance with the modules and components of system 100 above.

In an aspect, calendar 200 may contain a listing of events from a single calendar associated with a user (e.g., calendar 200 may only display events from the user's work calendar, personal calendar, family calendar, etc.). Alternatively, in another aspect, calendar 200 may contain an amalgamation of events obtained from two or more user calendars (e.g., calendar 200 may display some or all events from a user's work calendar, personal calendar, and family calendar).

To reduce clutter and improve clarity, calendar 200 may be configured to contain both a background layer and a foreground layer. Events in the background layer may be situated there for informational purposes. More particularly, these events may represent meetings and/or activities that a user would like to be apprised of, but doesn't want reflecting as hard time commitments to themselves or others. Conversely, events in the foreground layer may represent events that a user is committed to attending and may be more emphasized on calendar 200, as further described herein. It is important to note that the layers feature doesn't simply assign all events from an entire calendar to a single layer (e.g., allocating all events identified on the user's personal calendar to the background layer while simultaneously placing all events identified on the user's work calendar on the foreground layer), but rather, events from any calendar may appear in the background or foreground layer. For instance, all events from a user's work and personal calendar may be represented on a single calendar, and a first subset of those collective events may be situated in the background layer and a second subset may be situated in the foreground layer.

In an aspect, background events (e.g., 22, 24, etc.) may be visually distinguished from foregoing events (e.g., 26, 28, etc.) in various ways. For instance, background layer events may: be presented with fewer details (e.g., events may just contain the event title, events may just contain a generic background layer designation, such as “Awareness,” etc.), be visually de-emphasized (e.g., via greying-out, background blending, etc.), be positioned behind a concurrent foreground event, and the like. Foreground layer events may: be presented with greater information (e.g., a meeting title and description, meeting location, meeting attendees, etc.), be visually emphasized (e.g., by highlighting or bolding a meeting edge, by representing the foregoing event in a different color than the background event, etc.), be positioned in front of a concurrent background event, and the like. It is important to note that any combination of the foregoing techniques for visually distinguishing background events from foregoing events may be utilized. It is also important to note that other techniques for visually distinguishing background events from foreground events, not explicitly described here, may also be utilized.

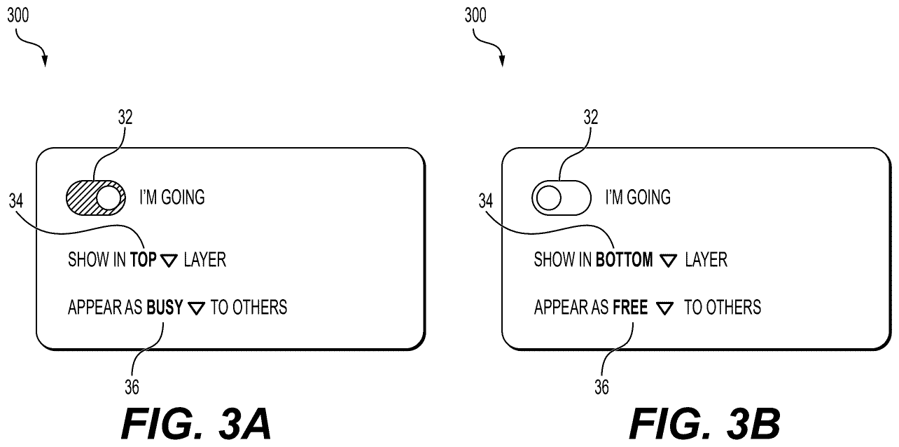

Further to the foregoing, another aspect associated with the “layers” feature is an availability control, also known as an “I'm going” control. The availability control may enable a user to easily differentiate those events they are committed to attending from those events they just want to be apprised of. In an aspect, the attendance control may behave as a type of preset control that sends events to the correct layer (e.g., the background or foreground layer) and adjusts the user's availability accordingly. For instance, referring now to FIGS. 3A and 3B, an availability control 300 is illustrated in two different selection states. The availability control 300 may include an attendance toggle 32, a layer designator 34, and an appearance indicator 36. In FIG. 3A, user selection of the attendance toggle 32 to indicate they will attend an event may institute default settings in the layer designator 34 and appearance indicator 36. More particularly, the relevant event may appear in the foreground, or “top,” layer on their calendar and the user may appear busy to others during the designated duration of the event. Conversely, in FIG. 3B, if the user deselects attendance toggle 32, the event may be moved to the background, or “bottom,” layer on their calendar and the user may appear free to others.

Most practical situations may be correctly categorized by the default settings associated with either the “going” or “not going” selection on the attendance toggle 32. However, users may manipulate these default settings so that they can view their own events exactly as they wish to see them and may correspondingly make their calendar appear to others exactly as they wish it to appear. A plurality of exemplary situations are outlined below that detail how a user may customize settings of the availability control 300 to achieve their desired calendar configuration for an event.

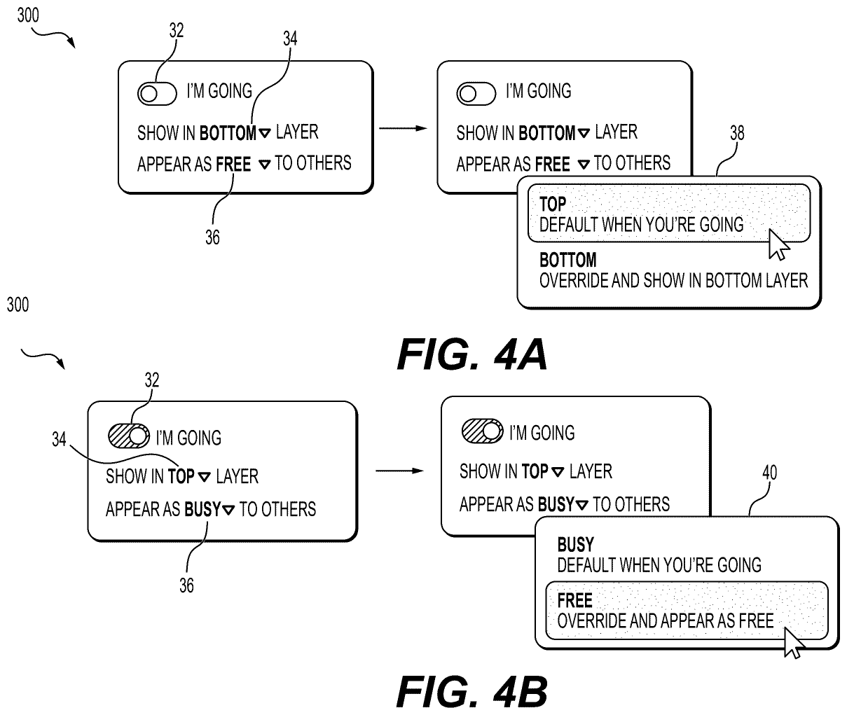

Referring now to FIGS. 4A and 4B, a situation may occur in which a user may want to appear free to others for an event, but may also want to have that event appear in the foreground layer. A user may accomplish this intent in two different ways. In one embodiment, as represented by availability control 300 in FIG. 4A, a user may indicate that they are “not going” via interacting with attendance toggle 32 and may move the event to the top layer by selecting the “top” option in dropdown menu 38 that appears in response to interacting with layer designator 34. In another embodiment, as represented by availability control 300 in FIG. 4B, a user may indicate that they are “going” via interacting with attendance toggle 32 and may designate to others that they are free during the duration of the event by selecting the “free” option in dropdown menu 40 that appears in response to interacting with appearance indicator 36.

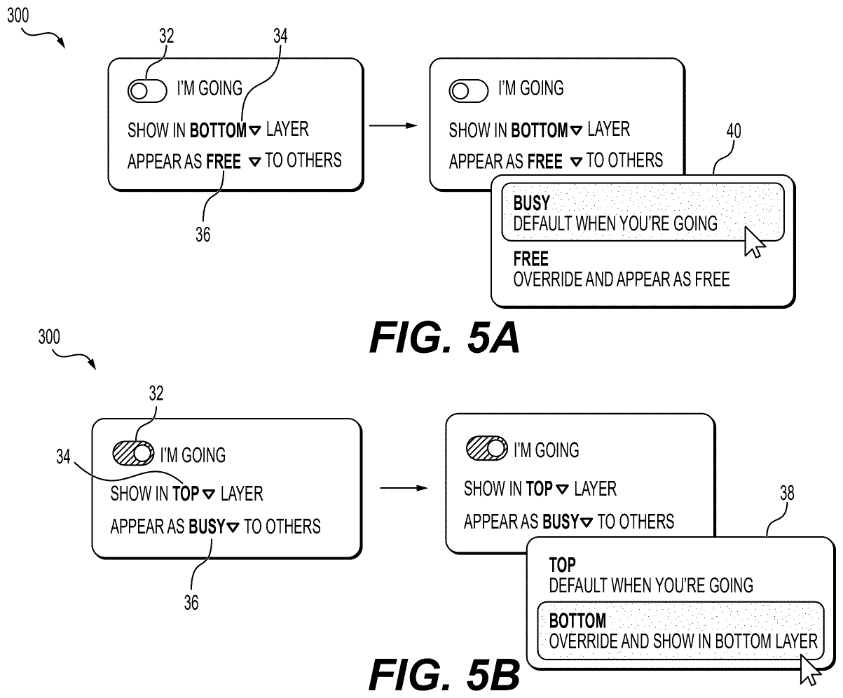

Referring now to FIGS. 5A and 5B, a situation may occur in which a user may want to appear busy to certain individuals (e.g., co-workers, clients, etc.) but may want that event block to appear in the background layer. A user may accomplish this intent in two different ways. In one embodiment, as represented by availability control 300 in FIG. 5A, a user may indicate that they are “not going” via interacting with attendance toggle 32 and may designate to others that they are busy during the duration of the event by selecting the “busy” option in dropdown menu 40 that appears in response to interacting with appearance indicator 36. In another embodiment, as represented by availability control 300 in FIG. 5B, a user may indicate that they are “going” via interacting with attendance toggle 32 and may move the event to the bottom layer by selecting the “bottom” option in dropdown menu 38 that appears in response to interacting with layer designator 34.

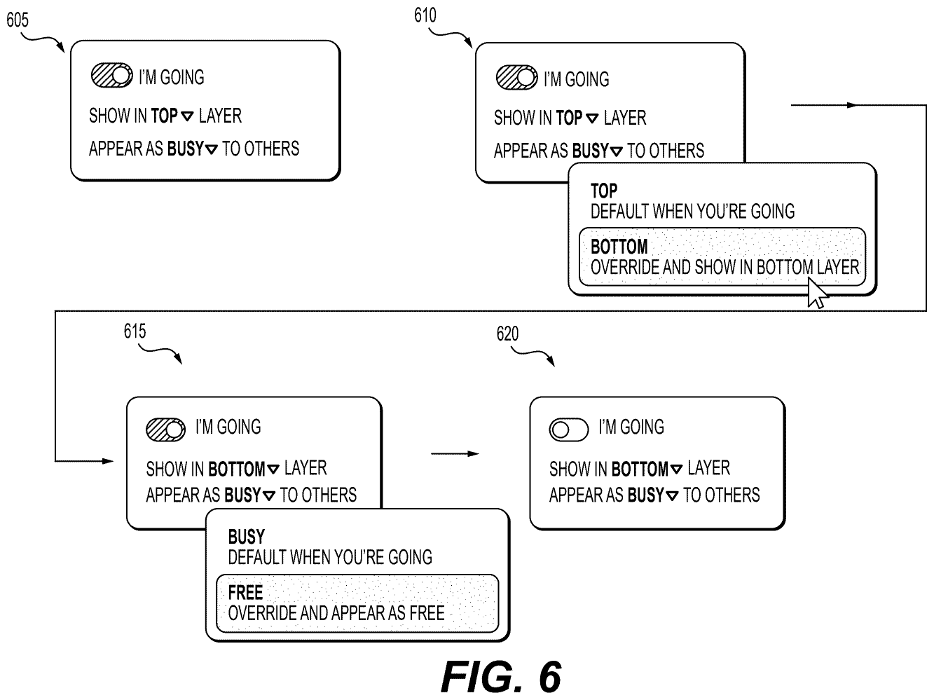

Referring now to FIG. 6, if a user independently adjusts selections in layer designator 34 and appearance indicator 36 to match existing default settings, then system 100 may dynamically adjust attendance toggle 32 to the matching default selection. For instance, availability control 300 at 605 may originally be set to the default settings associated with an “I'm going” selection of attendance toggle 32. If a user adjusts, at 610, layer designator 34 to a background layer and adjusts, at 615, appearance indicator 36 to appear free during the duration of the event, then system 100 may automatically adjust, at 620, attendance toggle 32 to represent a “not going” selection because the selections in layer designator 34 and appearance indicator 36 match the default settings associated with a “not going” selection. An exception to the foregoing is a meeting RSVP. More particularly, if a user accepts an event invitation and subsequently changes their availability during the event to appear as “free” and also assigns the event to the bottom layer, the system 100 would not adjust their initial response to the meeting invite (e.g., system 100 would not update the RSVP response to “not going”).

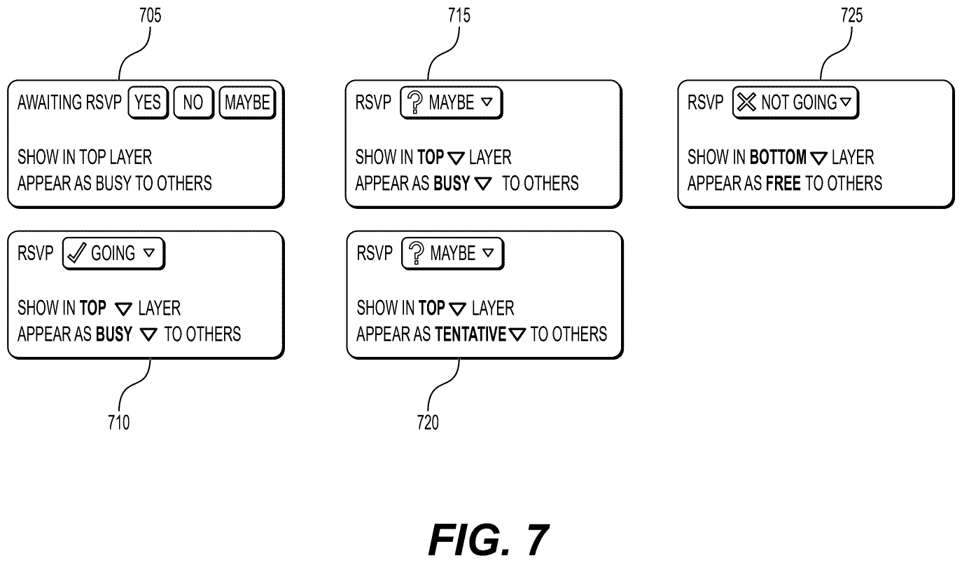

In an embodiment, when a user is invited to an event, the event's RSVP may take the place of the “I'm going” toggle. For instance, referring now to FIG. 7, an exemplary option flow is presented for responding to an RSVP for an event. At 705, a user may receive an invitation to attend an event and may be presented with three options: “yes,” “no,” or “maybe.” If a user indicates that they will attend the event (e.g., by selecting the “yes” option) then the event may be placed in the calendar's top layer, as represented at 710, and the user may appear as “busy” to others, a designation that the user may adjust by interacting with appearance indicator 36. If a user indicates that they may attend the event (e.g., by selecting the “maybe” option), then the event may be placed in the calendar' top layer. In an embodiment, the setting associated with the appearance indictor 36 may be dictated by the email platform the user is utilizing. For instance, the appearance indicator 36 may contain a default setting to appear as “busy” on a first platform, as represented at 715, and a different default setting, e.g., to appear as “tentative”, on a second platform, as represented at 720. If a user indicates that they will not attend the event (e.g., by selecting the “no” option), then the event may be placed in the calendar's bottom layer, as represented at 725, and the user may appear as “free.” In an embodiment, until a user responds to the meeting invitation, the meeting may remain in the user's top layer on their calendar.

Manipulation of the settings in an availability control may be relatively straightforward when dealing with personal and/or work-based events, as previously described above. However, events on shared calendars (e.g. a family calendar) operate differently. For instance, most properties of events are shared among each member in the calendar group. More particularly, if a user changes the appearance designation for an event in a shared calendar, the designation changes for all users that can see the calendar. Accordingly, when a user selects an “I'm going” option via interaction with an attendance toggle for a shared calendar, system 100 may write “I'm going” selection, the “appear as” value, and the “layer” value to a user-specific event property database. The appearance indicator remains unchanged in the underlying event. In an aspect, if a user changes the “I'm going” designation in a shared calendar, it will only change the appearance for them. Additionally, a set of blocking preferences may be available for the user to interact with to designate the correct main calendar (e.g., work calendar, personal calendar, etc.) to be blocked at the selected time to represent that the user is busy. In another aspect, an “I'm going” “family feature” option may be available that may enable a user to set/adjust the “I'm going” designation for other family members.

### Popover Window Behavior

In an embodiment, when the user adjusts their attendance status for a repeating meeting, system 100 may need to confirm the user's intention before implementing the requested change. For instance, system 100 may generate one or more follow-up queries to clarify whether they would like to adjust their attendance status for a single event, a plurality of events in a series, or all upcoming events (e.g., for a predetermined period of time, etc.).

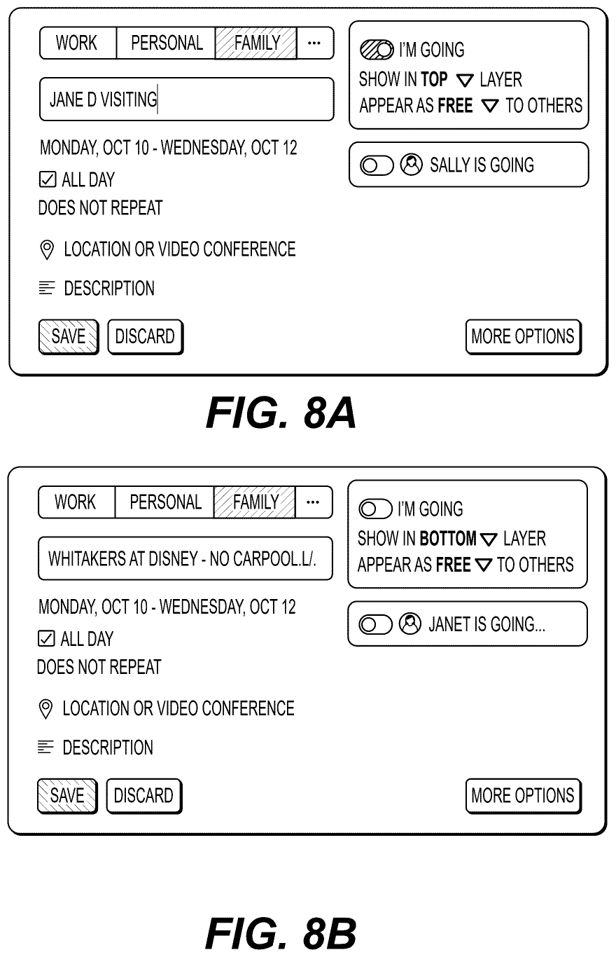

In an embodiment, events that are scheduled to last the entire day, also known as “all-day” events, may be treated in a specialized manner. For instance, the appearance indicator on an availability control may designate that the user is “free,” regardless of the attendance designation that they selected. For instance, in FIG. 8A a user has indicated that they will attend an event, correspondingly causing the event to be listed in the top layer. In FIG. 8B, a user has indicated that they will not attend an event, correspondingly causing the event to be listed in the bottom layer. In both instances, the designation by appearance designator indicates that the user is free during a duration of the event. In an embodiment, the user may manipulate which layer the all-day event appears on (e.g., top or bottom layer). However, the status of attendance toggle may directly correspond to the layer designation and may correspondingly change to reflect the layer adjustment.

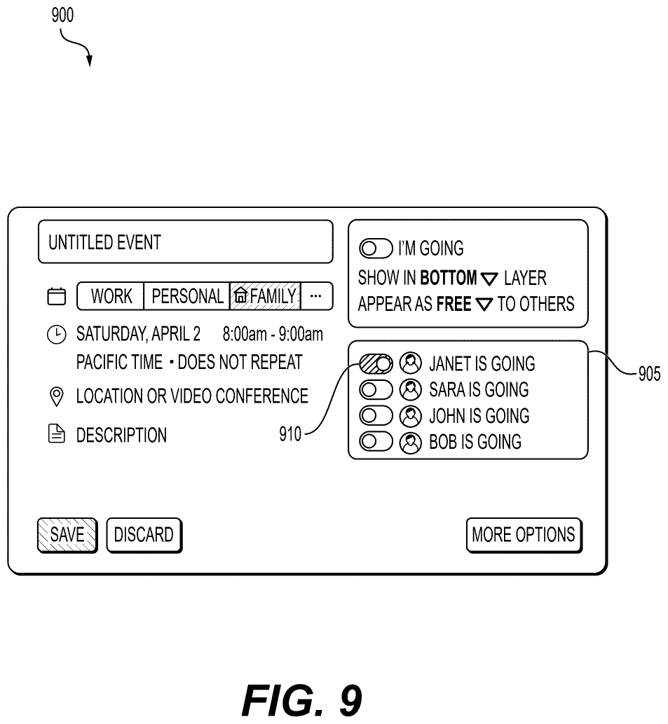

In some situations, event creators may “opt in” other group members to events on the shared calendar. For instance, referring to FIG. 9, an event scheduler popup 900 is presented that may contain, among other things, a group member attendance indicator 905. The group member attendance indicator 905 may list the individuals associated with the shared calendar and may contain an indication of which of these individuals plans to attend the event (e.g., by explicitly indicating in text form whether an individual is going or not, by visually bolding or fading the individual's name, etc.). In an embodiment, a user may opt one of the group members into the event by, for example, interacting with an attendance toggle 910 associated with the target user. Upon opting another user into an event, the “opted-in” user may see an adjustment to their attendance control associated with that event. More particularly, for the opted-in user, the attendance toggle may be adjusted to an “I'm going” designation, the event may be placed in the foreground layer, and their appearance designator may be set to appear as “busy” to others. In an embodiment, the individual that had been opted-in may be notified (e.g., via a notification transmitted by and/or through the calendaring application). In some embodiments, if the other individual has cross-calendar blocking enabled, then their calendar, and corresponding options present in their attendance control, may be blocked from being edited by others.

In an embodiment, certain default settings may exist for newly created events and newly accepted events. With respect to the former, in an embodiment, system 100 may automatically designate the user as “going” to a new event that they created. In another embodiment, system 100 may implement the most recent attendance designation that the user set the last time the user created an event for the relevant calendar. For instance, if the user designated that they were not going to the most recent personal event that they created, then system 100 may automatically assign a “not going” designation to the attendance toggle for the newest created personal event. With respect to the latter, in an embodiment, system 100 may implement a default “not going” attendance designation to events that another individual has created. Additionally or alternatively, system 100 may correspondingly automatically allocate events created by others to the background layer. In an embodiment, all of these default settings may be changed in a settings menu. To make users aware of this setting, the first time a user changes an event's attendance designation on a group calendar for an event that they didn't create, system 100 may prompt the user and ask them to confirm their intention to change the default setting.

### Tags, Lenses, and Rules

The proliferation of information within digital calendars creates a substantial challenge when attempting to extract meaningful insights. Users often open their calendars with specific questions in mind, such as determining the timing of important meetings, identifying free weekends, or understanding the duration until a particular milestone. However, conventional calendars lack the flexibility and tools necessary to provide quick and easy answers to such questions, thereby causing users to engage in laborious searching to identify the information they need.

Conventional attempts to address the foregoing calendar limitations have primarily focused on improving user interfaces and adding features for better event management. However, these attempts fall short in providing the customization and flexibility required to answer diverse questions and scenarios. Specifically, existing calendars lack the ability to save multiple views, highlight specific events dynamically, and automate organizational tasks.

The concepts described in this section introduce three key features to address conventional issues and improve digital calendar visualization: “Tags,” “Lenses,” and “Rules.” Tags are user-defined metadata used to group events, providing a flexible way to categorize and organize information. Users may add tags like “important,” “golf,” or associate a name as a tag with a specific event, thereby enhancing customization. Lenses are user-defined rulesets for displaying events, enabling users to save and switch between multiple customized views. For instance, users can define which events to display, apply color schemes to those events, and set specific views. Rules enable users to automate the application of tags to events based on search criteria. For instance, similar to filters in email systems, rules allow users to tag events automatically, thereby streamlining the organization process.

Tags represent user-defined metadata used to group events together. More particularly, events assigned the same tag may collectively be distinguished from other events on a user's calendar in a simple and intuitive way, as further described herein. In an embodiment, events allocated the same tag may be events that are same (e.g., a recurring event), that share a similar theme or involve a similar activity (e.g., two independent golf outings may both be assigned a “golf” tag, a scheduled run and a scheduled lifting session may both be assigned a “workout” tag, etc.), and/or that may be of equal weight in the eyes of the user (e.g., a critical presentation for work and a child's playoff game may both be tagged as “important,” etc.).

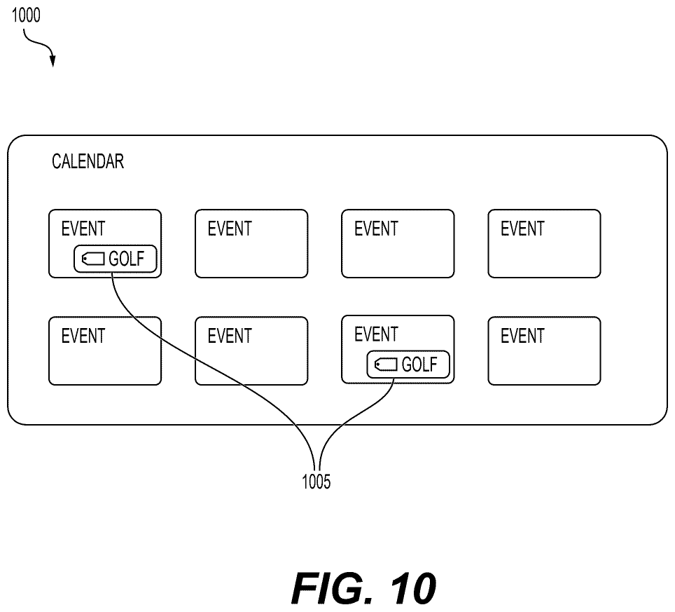

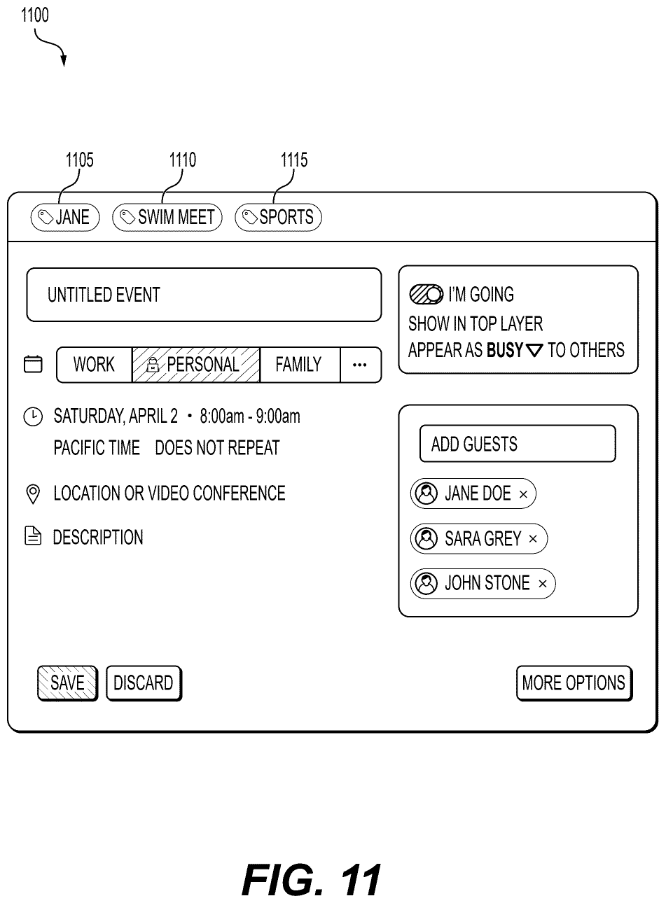

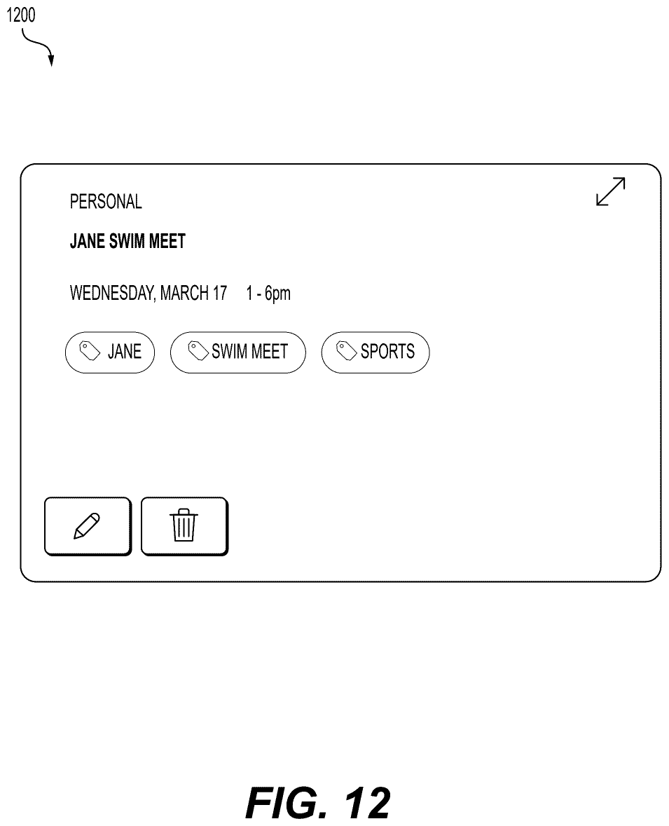

Referring to FIG. 10, an exemplary overview of a user's calendar 1000 is presented. Calendar 1000 may be populated by a plurality of events. A user wanting to associate a subset of those events with one another may add a tag 1005 to the target events, e.g., a user of calendar 1000 may add a “golf” tag to certain golf-related events. In one embodiment, tags may be assigned manually by a user, e.g., when creating or viewing an event. For instance, FIG. 11 presents an event scheduler 1100 that a user may interact with to construct a new event. The event scheduler 1100 may enable a user to add one or more tags that they would like the event associated with. For example, event scheduler 1100 contains three tags for “Olivia” 1105, “swim meet” 1110, and “sports” 1115. In an embodiment, the user may see the tags displayed when subsequently viewing the event, as shown in event preview 1200 in FIG. 12.

In another embodiment, system 100 may assign tags to events dynamically in one or more different ways. For instance, system 100 may identify that a user has previously manually assigned a tag to an event and may thereafter dynamically assign the same tag to a similar upcoming event. For example, responsive to identifying that a user has tagged a meeting with Individual A as important, system 100 may dynamically tag each future meeting with Individual A as important. As another example, system 100 may attempt to automatically assign relevant tags to each newly created or accepted event by, for example, analyzing subject matter associated with the event (e.g., contained in the event subject line, event description, event date, event duration, event location, invite list, etc.). For example, responsive to identifying a newly created event titled “scuba diving” that is scheduled to occur far away from the user's home (e.g., in a Caribbean island when the user lives in Washington), with the user's children, system 100 may add a “vacation” tag to the target event. In some embodiments, system 100 may automatically assign a tag to an event responsive to determining that a certain tag should be associated with a certain event. In another embodiment, system 100 may query the user to confirm the tag before it is assigned. In another embodiment, system 100 may initially provide a suggestion of a tag (e.g., during the first iteration of the event) that must be user-confirmed prior to formal implementation. Upon further iteration of the same or similar event, system 100 may obtain higher confidence in the tag assignments, and may, in some aspects, be configured to assign the tag automatically (e.g., without the need to receive any user confirmation input).

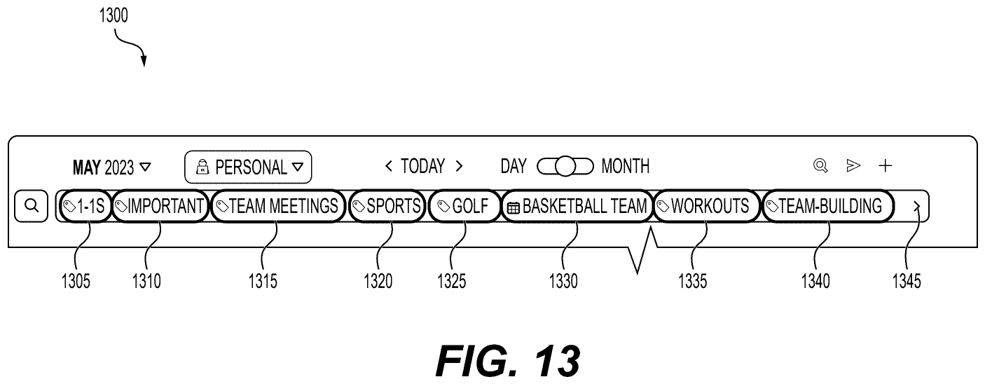

Referring now to FIG. 13, a tag bar 1300 is presented that is configured to provide users with a quick and accessible way to change how events are displayed. The tag bar 1300 may be integrated with and co-displayed with the user's calendar and may contain a scrollable listing of all tags that the events in the user's calendar have been associated with. For example, FIG. 13 illustrates that the events in a user's calendar include tags such as “1-1s” 1305, “important” 1310, “team meetings” 1315, “sports” 1320, “golf” 1325, “Golden State Warriors” 1330, “workouts” 1335, and “team building” 1340. Tag bar 1300 may contain a scroll icon 1345 that may be configured to dynamically appear when there are more tags than are able to be wholly presented in a single line of tag bar 1300. Upon selection of scroll icon 1345 by the user, additional tags that were not originally presented in the tag bar 1300 may be seen.

In an embodiment, the order of the tags 1305-1340 in tag bar 1300 may be presented in a variety of different ways. For instance, system 100 may be configured to chronologically populate the tag bar 1300 with new tags, from left to right, in the order that they are created (e.g., the “oldest” tag may be presented in the far left of the tag bar 1300 and the newest tag may be presented on the far right). Conversely, system 100 may be configured to present the newest tags in the far left position of the tag bar 1300 and gradually move existing tags to the right (or off-screen if the tag bar 1300 becomes over-populated). In another embodiment, system 100 may be configured to organize tags intelligently, e.g., based on certain contextual factors. For instance, tags associated with events that are upcoming earlier may be positioned on tag bar 1300 before tags associated with events that are scheduled to occur later. As another example, tags associated with a greater number of events may be positioned on tag bar 1300 before tags associated with a fewer number of events. In an embodiment, a user may adjust the position of any of the tags in tag bar 1300 (e.g., by selecting and dragging the target tag to the desired position). In an embodiment, once all events containing a particular tag have occurred, the relevant tag may dynamically be removed from the tag bar 1300.

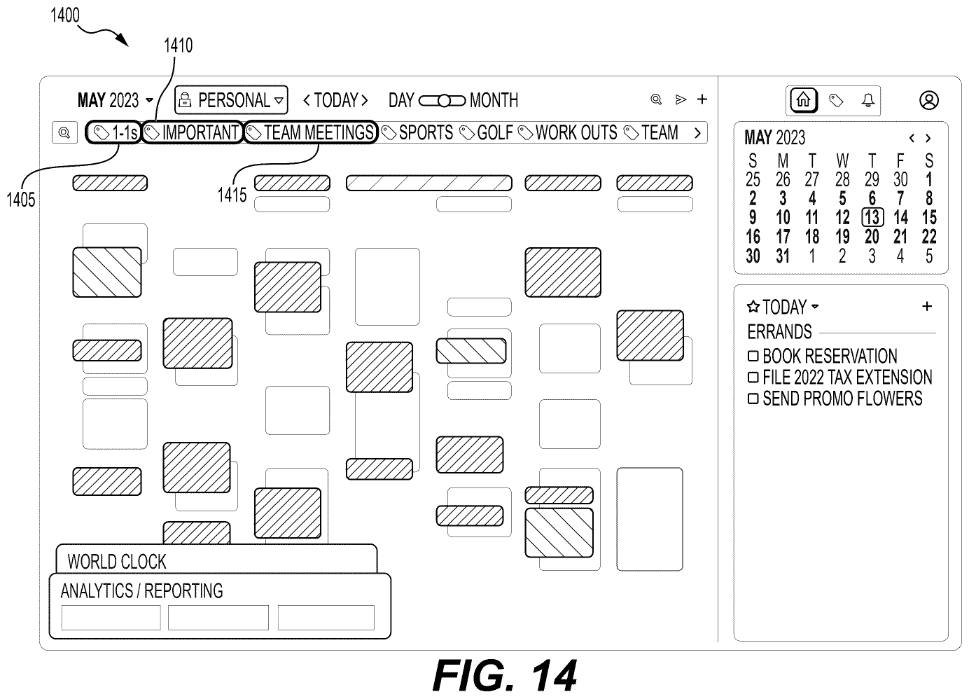

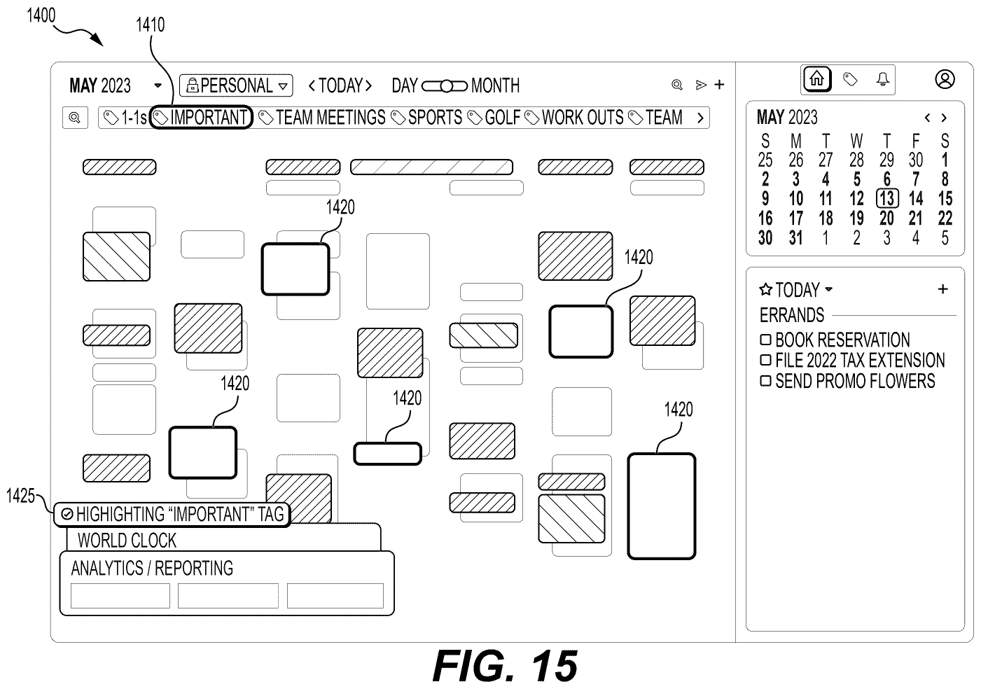

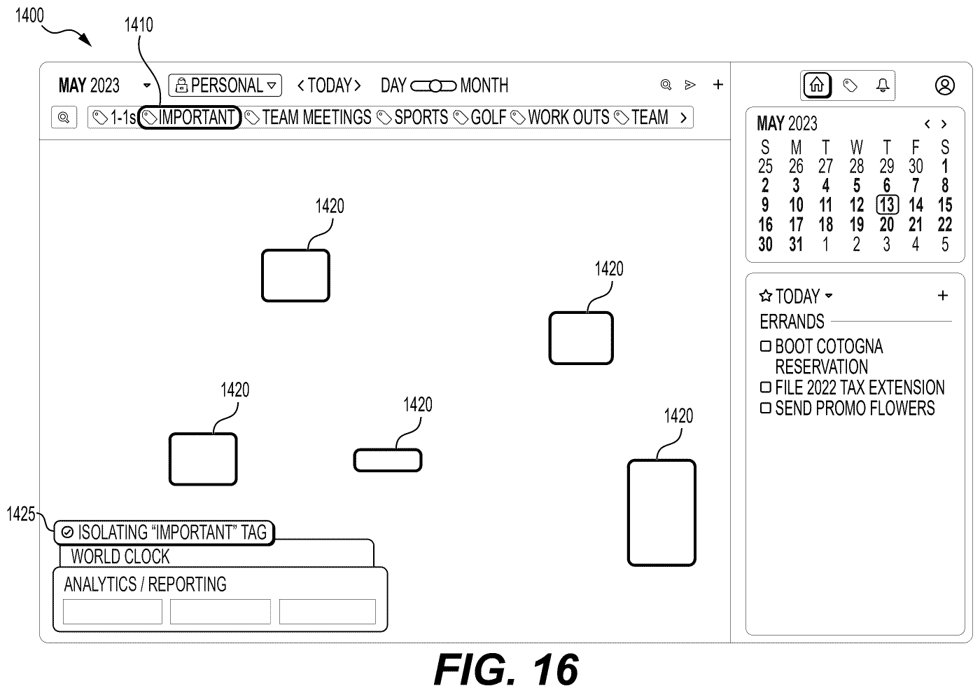

In an embodiment, the user may visually distinguish events having a certain tag from other events via interactions with the tag bar 1300. For instance, referring now collectively to FIGS. 14-16, a process is illustrated for visually distinguishing tagged events. FIG. 14 illustrates a calendar 1400 containing a plurality of events situated in both the foreground and the background layer. Upon user selection of the “important” tag 1410 in tag bar 1405, all events 1420 tagged as “important” will be visually distinguished from other events that did not have that tag, as shown in FIG. 15. For instance, all tagged events 1420 may be presented with a specific color, may have a bolded border, etc. Correspondingly, the “important” tag 1410 may be visually distinguished (e.g., via highlighting, coloring, shading, etc.) from other tags in the tag bar 1405 to reflect this selection. Additionally or alternatively to the foregoing, a popup notification 1425 may be displayed to the user indicating which tag was highlighted. As another example of the foregoing process, selection of the “important” tag 1410 may cause all other events not tagged as “important” to be temporarily removed from calendar 1400, as shown in FIG. 16.

In an embodiment, an increasing visual emphasis on the tagged events may occur from repetitive user interaction with an event tag in the tag bar 1405. For instance, a user may select the “important” tag 1410 once to visually emphasize the “important” events, as shown in FIG. 15, and upon selecting the “important” tag again, all other events not designated as “important” may be temporarily removed from the calendar 1400, as shown in FIG. 16. In another scenario, not explicitly pictured, in some embodiments a user may select a tag once to visually de-emphasize the corresponding tagged events (e.g., by graying out) and may further visually de-emphasize the tagged events (e.g., by excluding them from view) upon a subsequent selection of the tag. In some aspects, this de-emphasis feature may be actuated from the GUI screen or may actuated from another screen or device (e.g., a keyboard option may be configured to perform the tagged event de-emphasis). In an embodiment, a user may select more than one tag from the tag bar 1405. For instance, the user may select the “important” tag 1410 as well as the “sports” tag 1415. Upon this dual-tag selection, all events having the tag “important” or “sports” may be visually distinguished from the other events in the calendar 1400.

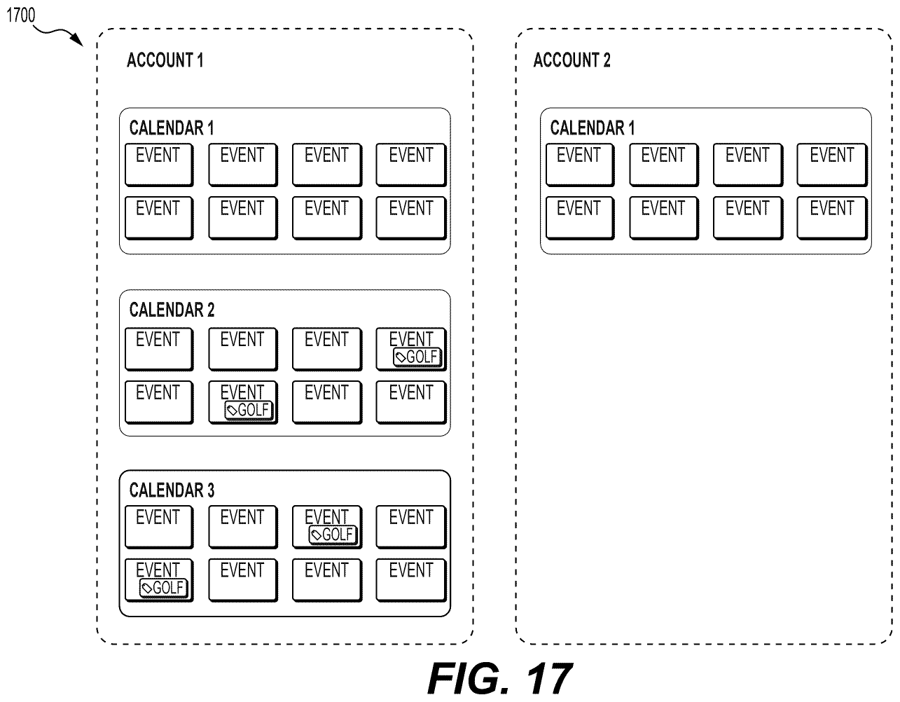

Turning now to the concept of “lenses”—while “tags” give the user the power to customize what they see, “lenses” give the user the power to save those customizations. More particularly, in the context of this application, “lenses” are user-defined, save-able rulesets that may control: which events to display, which colors to apply to each event, which calendar view to default to, whether to override an event's default layer, and the like. Through the combined use of “tags” and “lenses,” users may create the best view to suit every need. For example, with reference to FIG. 17, an exemplary overview 1700 is presented of a plurality of user calendars across two different user accounts. Each calendar may have a dedicated purpose or theme (e.g., a work-based calendar, a personal calendar, a family calendar, etc.) and may contain events related to that theme. Upon instructing/toggling a lens to display any events having a specific tag (e.g., “golf”), then each tagged event may be shown to the user, regardless of whether the calendar is selected or not.

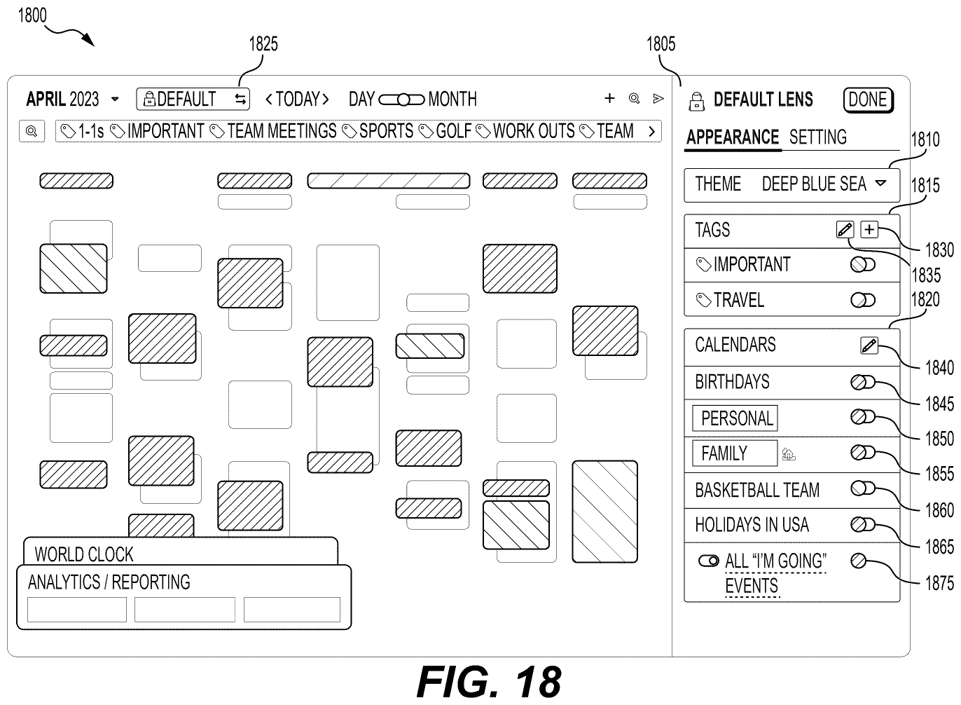

Referring now to FIG. 18, an exemplary lens interface 1800 is presented according to an embodiment. A user may interact with a lens control panel 1805 to select specific tags and calendars to display and also to customize how the events in the calendar are presented. The lens control panel 1805 may contain a theme selector 1810, a tag settings panel 1815, a calendar settings panel 1820, and a lens selector toggle 1825, aspects of all of the foregoing are further described herein.

To open the lens control panel 1805, a user may, for example, select the lens selector toggle 1825. Lens selector toggle 1825 may always provide an indication to the user of a currently active lens (e.g., in FIG. 18 a “Default” lens is displayed). A user may select, via interaction with the lens selector toggle 1825, a particular lens that they would like to edit. Subsequent to this selection, the lens control panel 1805 may appear on the screen for the selected lens and may enable a user to customize settings associated with it.

A user may interact with a tag settings panel 1815 to adjust the appearance of tagged events for a particular lens. A user may select one or more existing tags to include in the selected lens via interaction with icon 1830 and may customize the color assignment associated with the events containing the included tag(s) by interacting with icon 1835. For instance, tag settings panel 1815 in FIG. 18 includes two designated tags, “important” and “travel”. The “important” tag has a peach color assignment (represented by vertical striped lines) and the “travel” tag has a yellow color assignment (represented by the horizontal striped lines). If a user has indicated that they will be attending an event tagged as “important” or an event tagged as “travel,” and the current lens is active, then those events may be displayed with the designated colors orange and yellow, respectively.

In an embodiment, the order of events listed in the tag settings panel 1815, from top to bottom, may represent a hierarchical prioritization of color assignments. More particularly, a single event may contain multiple tags. In such a situation, the color assignment associated with the highest prioritized tag will be applied to the event when the lens is active. For instance, in FIG. 18, an event associated with the “important” tag and the “travel” tag may be represented in orange, e.g., the color assignment associated with the “important” tag.

A user may interact with a calendar settings panel 1820 to control the specific calendars from which events may be displayed, and designate the corresponding color of those displayed events, when a lens is active. In an embodiment, calendar settings panel 1820 may contain a listing of all known calendars associated with a user. Each listed calendar may be associated with a toggle that, when selected, may instruct lens control panel 1805 to display all events that the user plans to attend that are associated with the relevant calendar. For example, because each calendar listed in 1820 has been selected (e.g., as indicated by the active toggles), then all events that the user has indicated they will attend, across all calendar, will be displayed.

In an embodiment, the toggle associated with each calendar may be represented in a color, which may dictate how events associated with that calendar are displayed. The color associated with each toggle may adjusted through interaction with icon 1840. As an example of the foregoing, calendar settings panel 1820 in FIG. 18 contains a “Birthdays” calendar 1845, a “Personal” calendar 1850, a “Family” calendar 1850, a “Golden State Warriors” calendar 1860, and a “Holidays in United States” calendar 1865. The toggles associated with calendars 1845, 1850, 1855, and 1865 are represented by a first color (e.g., blue, as visually represented by a solid circle) whereas the toggle associated with calendar 1860 is represented by a second color (e.g., orange, as represented by an empty circle). This indicates that when the current lens is active, events that the user is attending that are associated with calendars 1845, 1850, 1855, and 1865 may be presented with a blue color whereas events that the user is attendeding that are associated with calendar 1860 are presented with an orange color. In some aspects, a particular event that the user does not intend to attend (but wants to be aware of) may be promoted to a specific layer of a calendar and may be presented in the same color as other events in that layer that the user plans to attend. In an embodiment, calendar settings panel may include a “show all” toggle 1870 that, when activated, may show all events that the user is planning to attend, regardless of calendar. Color indicator 1875 may represent the color that would be applied to any event that had not already been assigned a color based on a calendar or tag.

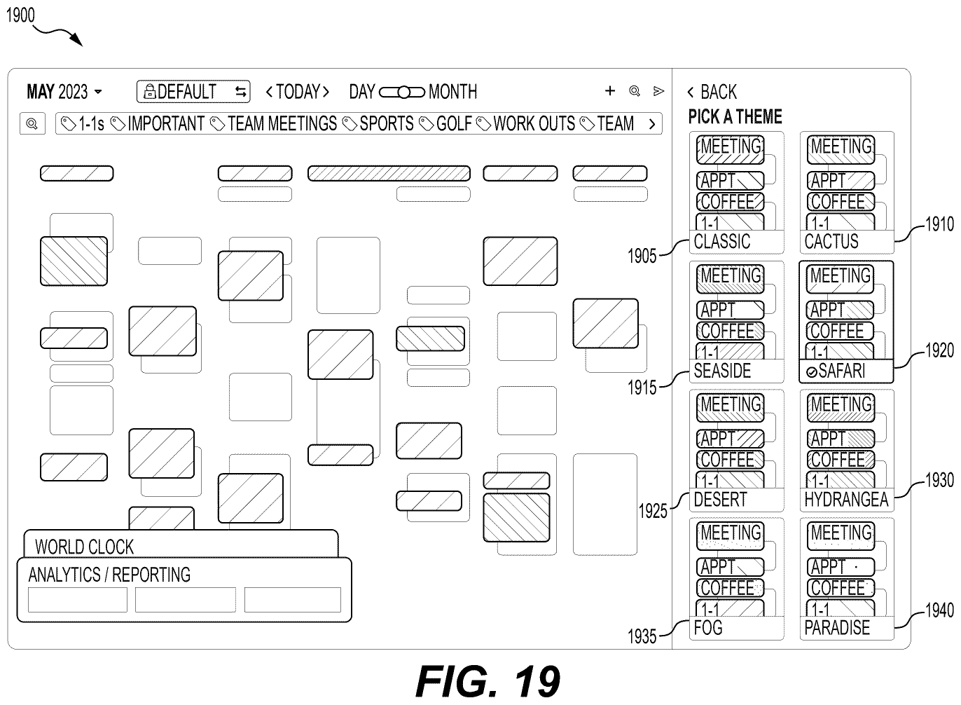

Because choosing a visually appealing color scheme may be difficult to do, users may be able to interact with theme selector 1810 to choose from a multitude of pre-configured themes. For instance, FIG. 19 illustrates calendar 1900 that contains a plurality of different color theme palettes, e.g., “Classic” 1905, “Cactus” 1910, “Seaside” 1915, “Safari” 1920, “Desert” 1925, “Hydrangea” 1930, “Fog” 1935, and “Paradise” 1940. Each color theme palette may have specific designations for how: events associated with certain tags appear, events associated with certain calendars appear, etc. In an embodiment, each color theme palette may have two categories of color: complementary colors and highlight colors. With respect to the former, complementary colors may provide subtle differentiation between events, but blend well together to form an aesthetically appealing calendar. With respect to the latter, highlight colors may provide more of a contrast, thereby visually emphasizing the events the user wants to stand out. Upon selection of a certain color theme palette, e.g., “Safari” 1920, the color assignments for all relevant events will be adjusted to match the color themes in the selected color theme palette. In an embodiment, system 100 may be able to dynamically generate context-based color theme palettes that incorporate colors that are prominently associated with a specific area or region (e.g., city, state, country, etc.). For instance, a user visiting Pittsburgh may be able to select a “Pittsburgh” palette that contains color designations (e.g., black and gold) that are often associated with the sports teams of the region.

Turning now to the concept of “rules,” users may leverage a search functionality associated with the calendaring platform to more easily apply tags to the searched event. More particularly, users may perform a search across all events to identify which events contain certain attributes. System 100 may be configured to then automatically apply one or more tags to each event that contains the targeted attribute(s).

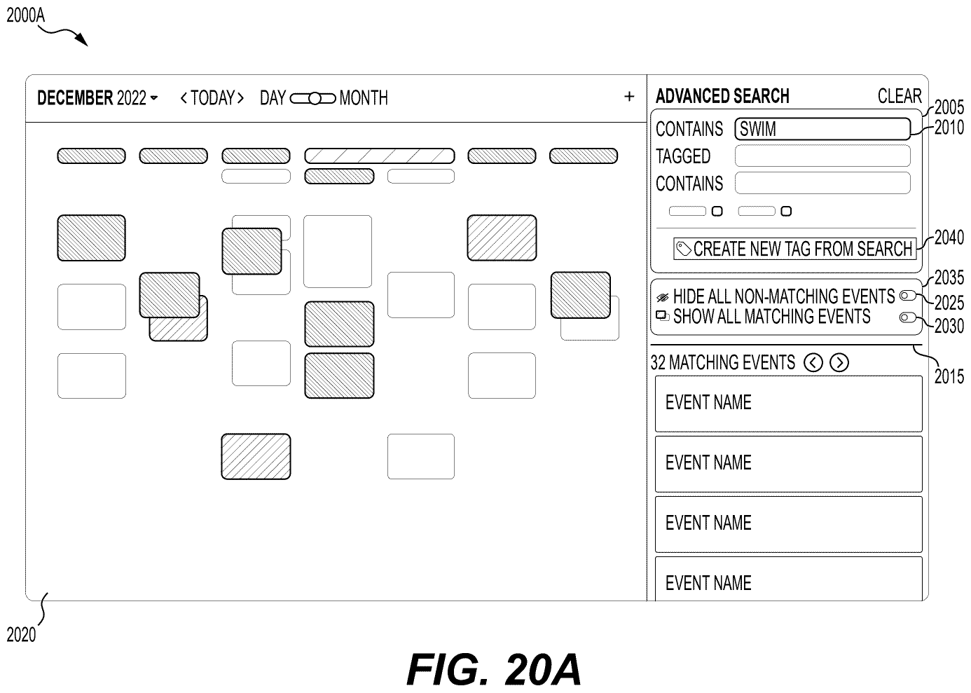

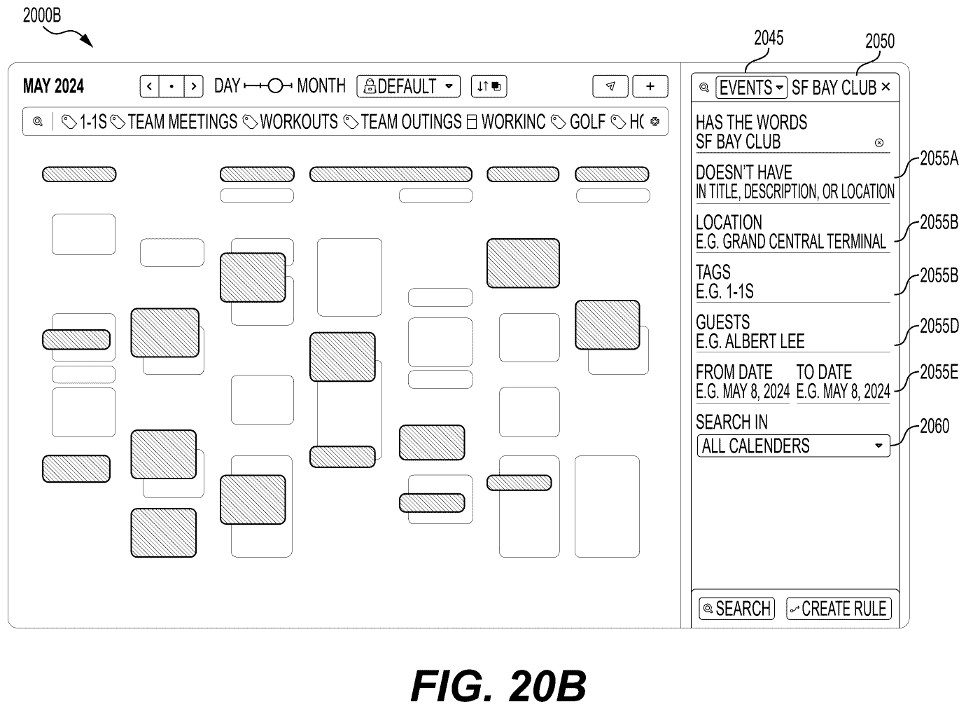

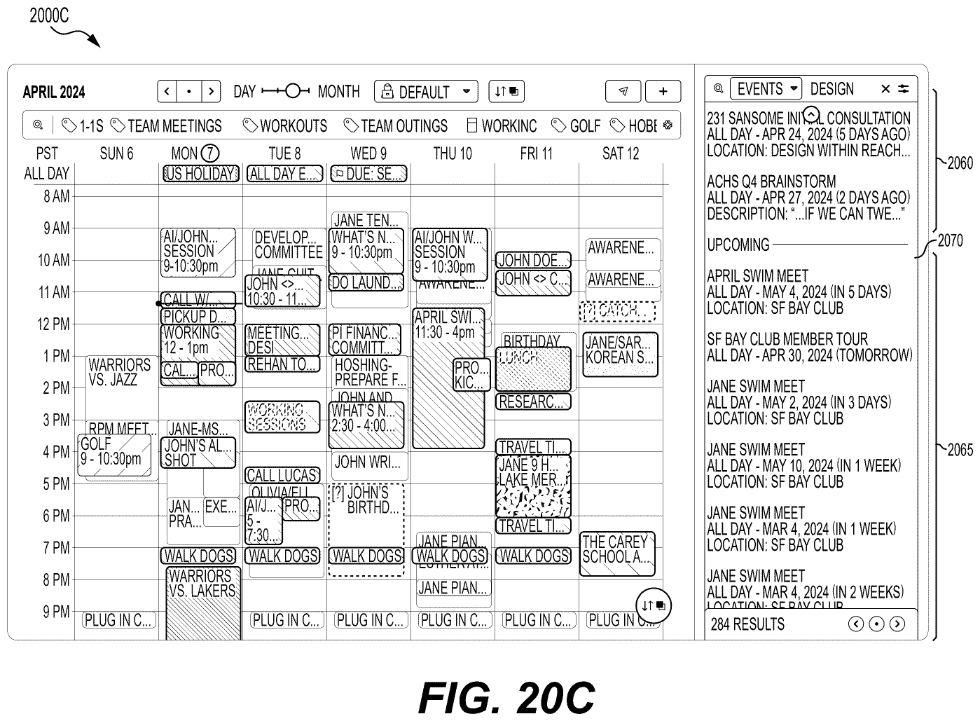

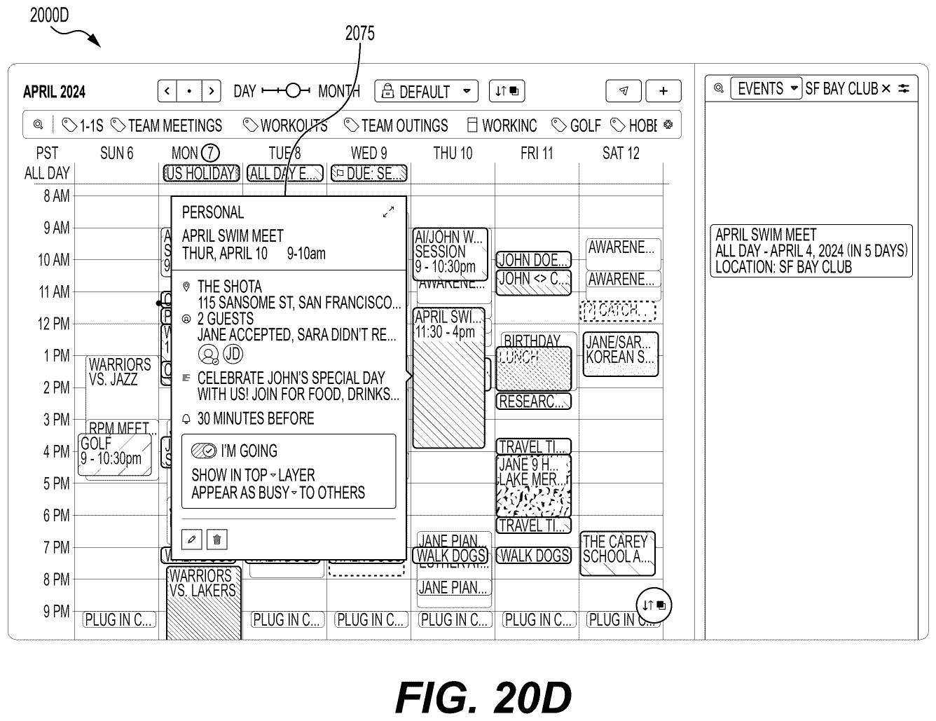

Referring now to FIG. 20A, an exemplary search interface 2000 is presented according to an embodiment. A user may interact with a search panel 2005 to designate one or more criteria that they would like system 100 to search for in their events. For example, a user may type a term into an input field 2010, e.g., “swim,” and system 100 may then search through their events to determine if any event contains the term, “swim.” Any events determined to contain the searched criteria may be listed in results section 2015. In an embodiment, the order of the presented events in results section 2015 may be based on determined relevance (e.g., events determined to more closely match the search criteria may be situated higher on the list of events in results section 2015). Additionally or alternatively, the search results may be visually distinguished on calendar 2020 based on user interactions with toggles 2025 and 2030 in results display panel 2035. More particularly, a user may choose to hide all non-matching events on calendar 2020 by selecting toggle 2025 and/or may choose to visually emphasize all matched events by moving the matched events to the top layer, e.g., by selecting toggle 2030. In an embodiment, a user may add one or more additional tags to any event in the search results by interacting with icon 2040.

It is important to note that the search example provided above represents just one exemplary way that a user may utilize search panel 2005 to search for and add a tag to an event. Users may leverage characteristics of search panel 2005 to perform more granular and/or different kinds of searches. For instance, users may specify the specific fields having user-facing text that they want system 100 to search for the requested criteria in (e.g., in the event name, description, guest list including guest name and/or email address, location, tags, etc.). Additionally or alternatively, users may perform various types of non-string searches, including: events having a specific number of guests, events having guests with a specific email domain, events of a specific duration, events that are or are not repeating, events that have or do not have at least one other tag, and the like. Additionally or alternatively, users may place search restrictions on the search. For instance, a user may instruct system 100 to constrain text searches to a specific field (e.g., event name and location) or to constrain all searches to a specific calendar. Additionally or alternatively, search panel 2005 may be configured to handle various types of Boolean terms, such as “AND” or “OR” statements.

As an example of the foregoing, FIGS. 20B-20C illustrate alternative embodiments of an advanced search interface. Turning first to FIG. 20B, search interface 2000B may enable users to interact with a search toggle 2045 to designate the aspect of the calendaring platform that they want searched (e.g., events, message, contacts, etc.) and provide a search query into an input field 2050 that system 100 will search the designated aspect for. Search interface 2000B may also contain a plurality of other search input fields (e.g., a “Doesn't Have” field 2055A, a “Location” field 2055B, a “Tags” field 2055C, a “Guests” field 2055D, and a date range field 2055E) that users may interact with to further refine their search. Search interface 2000B may further contain a calendar designation toggle 2060 that enables users to designate which specific calendar they want searched.

Upon submitting a search request, search interface 2000C presents an exemplary listing of search results that correspond to the user's search query and their input designations. For instance, search interface 2000C may contain a first set of search results 2060 that correspond to all events that match the search criteria that have already occurred and a second set of search results 2065 that correspond to all upcoming events that match the search criteria. Should a user interact with a specific search result, e.g., search result 2070, then, in some aspects, system 100 may cause a popup window 2075 to be presented on the user interface that provides greater detail about the selected event and that a user may interact with, as illustrated in search interface 2000D of FIG. 20D.

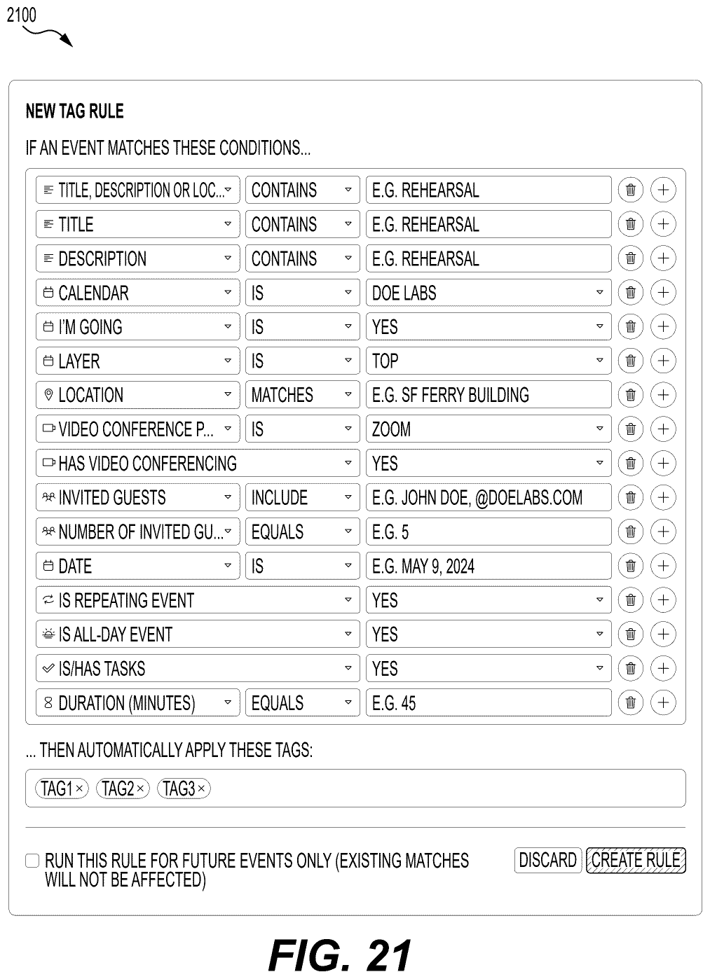

A plurality of non-limiting “rules” use cases for applying a tag to a search results are subsequently listed. In one use case, a tag may be applied to any event that includes a specific term (e.g., “golf,” “Marketing,” etc.) in any field (e.g., subject line, event title, event description, event location, event date, event duration, event attendee list, etc.). In another use case, a tag may be applied to any event that includes a specific term in a specific field (e.g., the term “golf” in the event title). In another use case, a tag (e.g., “1-1”) may be applied to any event with one guest that includes specific attendees. In another use case, a tag may be applied to events with external guests (or all internal guests). In another user case, a tag may be applied to all events that are repeating or non-repeating. In another use case, a tag may be applied to events with a location containing a zip code. In another use case, a tag may be applied to events with a zip code that is greater than a predetermined threshold distance away from the user. In another use case, a tag may be applied to all events where the listed event duration is greater than a threshold set of time. It is important to note that the types of “rules” listed above are non-exhaustive, and a variety of other “rules” may be applied to create a tag. For instance, FIG. 21 presents a variety of different types of rulesets that a user may interact with to control how a system assigns a particular tag to an event.

### Smart Metrics

Understanding how time is utilized is crucial for effective time management. However, traditional digital calendars lack the ability to offer meaningful insights into past time usage, making it challenging for users to reflect on their habits and optimize future schedules. Conventional attempts to address time management challenges have primarily focused on user interfaces, event organization, and task management. While these attempts have provided basic functionality for scheduling and viewing events, they fall short in offering advanced metrics for analyzing time usage patterns. Specifically, existing tools lack the granularity required to provide detailed insights into specific tag-related data, thereby hindering the user's ability to optimize their time effectively.

The concepts described in this section introduce smart metrics that are designed to address the limitations of conventional calendars and that may empower users with advanced insights into their time usage. One feature introduced in this section are “mini-metrics,” which are quick and convenient gauges that provide users with nuggets of information to help them stay on track. Users may customize mini-metrics per view and per lens (as previously discussed in the sections above), thereby allowing for tailored insights based on different contexts. Another feature involves “reporting,” which provides a more robust data analysis functionality that enables users to create visualizations and one-off reports based on a variety of event data. This feature allows for in-depth analysis of various events (e.g., tracking workouts per year by the day of the week, tracking the number of meetings shared with specific individuals, etc.). Tag-specific metrics represent yet another feature, which are utilized to incorporate metrics focused on specific tags, thereby allowing users to analyze how much time is allocated to events associated with a particular tag. Collectively, these metrics provide the user with a comprehensive understanding of past time usage-which they may ultimately leverage to make informed decision-making for future time planning.

Turning first to mini-metrics, a user may create, select from, and/or customize a specific mini-metric “view” that may provide them with helpful information regarding their time. In this regard, each “view” may consider scheduled events in a particular timeframe (e.g., in a day, a week, a month, a year, etc.) and provide temporal metrics associated with the events in that time frame. Additionally or alternatively, each “view” may be specifically themed and may provide metrics related to that theme. In an embodiment, mini-metrics may be used in association with a “working hours” settings menu that users may interact with to designate the hours of the week that they are working (e.g., those hours that a user is available to attend meetings and/or other work-based events).

In one embodiment, a user may choose to leverage a “Free Time” view that may provide indications of the total unallocated time in the designated view timeframe. In the context of this view, unallocated time may refer to any time within the view timeframe that has not already been designated to a scheduled event. Metrics associated with this view may be represented as minutes or hours available. For instance, given a “Free Time” view for an upcoming week, system 100 may provide the user with an indication that they have “27 free hours” during the upcoming week (wherein the total number of hours in the upcoming work week may be determined in view of a “working hours” setting, as previously discussed). In an embodiment, system 100 may either include or exclude the hours associated with a “non-working” day in its calculations to determine the free hours available for the user.

In another embodiment, a user may choose to leverage a “Focus Time” view that may provide various metrics associated with identified free time within a designated time frame that the user may use to focus on a project or task. In the context of this view, metrics associated with focus time may refer to: the total number of blocks of free time that satisfy certain criteria (e.g., the blocks of free time that are of a predetermined length, such as 60 minutes or more, etc.), the total number of events explicitly containing a “focus” tag and/or the cumulative time associated with “focus” tagged events, or a combination of the foregoing. In an embodiment, system 100 may either include or exclude the hours and/or events associated with a “non-working” day in its calculations to determine the focus metrics for the user in the designated time frame.

In another embodiment, a user may choose to leverage a “Countdown” view that may display the time remaining until the next event that matches a specific tag. For instance, a user may select a tag titled “board meeting” to keep track of all board meeting-related events so that they could be apprised of the number of days until the next board meeting to ensure that they are properly prepared beforehand. In an embodiment, system 100 may be configured to output the countdown data to the user in a variety of different ways. For instance, responsive to identifying that a target event is more than a threshold number of days away (e.g., more than 1 day away), system 100 may display a notification, such as “<days> from today until the next <tag>event.” In another example, responsive to determining that the target event is later in the day, system 100 may display a notification, such as “<hours>until the next <tag>event.” In each of the foregoing cases, the notification may contain additional event information (e.g., event name, event location, event summary, etc.). If there are no future events that match the tag, system 100 may be configured to display a notification, such as “No future events for <tag>.”

In another embodiment, a user may choose to leverage an “Event Count” view that may display the total number of events that match a specific tag. For instance, a user may want to know how many events are tagged as “important.” Responsive to receiving this request, system 100 may generate a notification to the user apprising them of the number of “important” tagged event. Additionally or alternatively, in another embodiment, the notification may also display the total hours for the sum of all matching events.

In another embodiment, a user may choose to leverage a “Total Hours” view that may display the total cumulative hours for events that match a specific tag. For instance, a user may want to know the total number of hours occupied by events that are tagged as “workout.” Responsive to receiving this request, system 100 may generate a notification to the user apprising them of the total hours that “workout” tagged events occupy on the calendar.

It should be understood that embodiments in this disclosure are exemplary only, and that other embodiments may include various combinations of features, as well as additional or fewer features, may be utilized. For example, some calendaring applications may leverage all of the concepts associated with “layers,” “tags,” “lenses,” “rules,” and “metrics,” whereas other calendaring applications may incorporate some subset of the foregoing features.

In general, any process or operation discussed in this disclosure that is understood to be computer-implementable may be performed by one or more processors of a computer system, such as any of the systems or devices in system 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as system environment 100, may include one or more computing devices. If the one or more processors of the computer system are implemented as a plurality of processors, the plurality of processors may be included in a single computing device or distributed among a plurality of computing devices. If a system environment comprises a plurality of computing devices, the memory of the computer system may include the respective memory of each computing device of the plurality of computing devices.

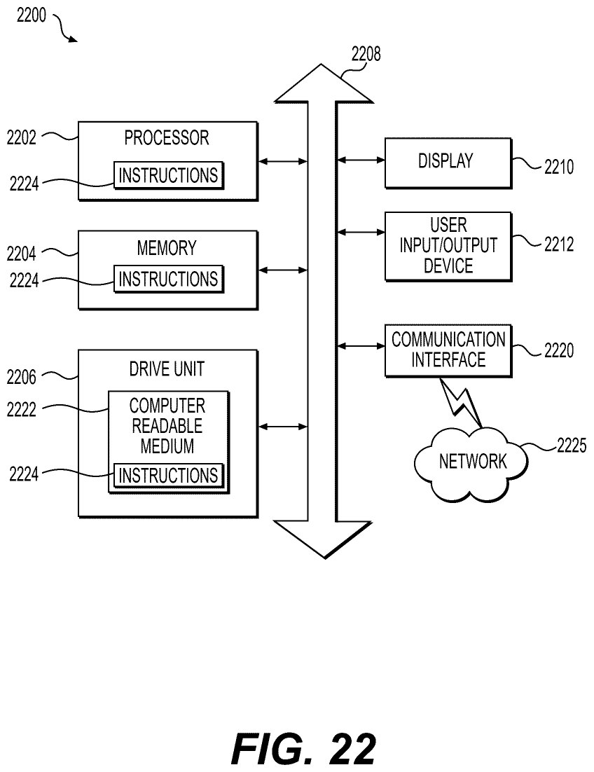

FIG. 22 is a simplified functional block diagram of a computer system 2200 that may be configured as a computing device for executing the processes described herein, according to exemplary embodiments of the present disclosure. In various embodiments, any of the systems herein may be an assembly of hardware including, for example, a data communication interface 2220 for packet data communication. The platform also may include a central processing unit (“CPU”) 2202, in the form of one or more processors, for executing program instructions. The platform may include an internal communication bus 608, and a storage unit 2206 (such as ROM, HDD, SDD, etc.) that may store data on a computer readable medium 2222, although the system 2200 may receive programming and data via network communications via electronic network 2225 (e.g., voice, video, audio, images, or any other data over the electronic network 2225). The system 2200 may also have a memory 2204 (such as RAM) storing instructions 2224 for executing techniques presented herein, although the instructions 2224 may be stored temporarily or permanently within other modules of system 2200 (e.g., processor 2202 and/or computer readable medium 2222). The system 2200 also may include input and output ports 2212 and/or a display 2210 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that the disclosed embodiments may be applicable to any environment, such as a desktop or laptop computer, a laboratory computing system, an office computing environment, etc. Also, the disclosed embodiments may be applicable to any type of Internet protocol.

It should be appreciated that in the above description of exemplary embodiments of the disclosure, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of this disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of this disclosure, and it is intended to claim all such changes and modifications as falling within the scope of this disclosure. For example, functionality may be added or deleted from the various calendaring interface and operations may be interchanged between them. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for managing an event on a data organizer application, the computer-implemented method comprising:
detecting, using a processor associated with the data organization application, an event associated with an electronic data organizer of a user;
presenting, using the processor and on the data organizer application, a control menu associated with the event, the control menu comprising an event attendance toggle;
receiving, from the user, input directed to the event attendance toggle;
assigning, using the processor and based on the received input, the event to a first layer or a second layer of the electronic data organizer, wherein events in the first layer are positioned in front of events in the second layer;
designating, using the processor and based on the received input, an availability state of the user for a duration of the event, wherein the availability state corresponds to an available state or an unavailable state;
displaying, using the processor and on the electronic data organizer, the event in the first layer or the second layer based on the received input; and
broadcasting, using the processor, the availability state of the user to at least one other user of the data organizer application.

2. The computer-implemented method of claim 1, wherein when the input corresponds to an attendance confirmation input, the assigning comprises assigning the event to the first layer and the designating comprises designating the availability state as the unavailable state.

3. The computer-implemented method of claim 1, wherein when the input corresponds to an attendance rejection input, the assigning comprises assigning the event to the second layer and the designating comprises designating the availability state as the available state.

4. The computer-implemented method of claim 1, further comprising assigning, using the processor, a tag to the event.

5. The computer-implemented method of claim 4, wherein the assigning the tag comprises assigning the tag automatically based upon analysis of details associated with the event contained in at least one of: an event title, an event description, an event location, an event duration, or an event attendee list.

6. The computer-implemented method of claim 4, further comprising:
receiving, at a tag control bar of the data organizer application, a user selection of at least one target tag;
determining, using the processor, that the tag assigned to new event is associated with the at least one target tag; and
visually distinguishing, using the processor, the event in the electronic data organizer from at least one other event displayed on the electronic data organizer that is not assigned the tag.

7. The computer-implemented method of claim 6, wherein the visually distinguishing comprises representing the event with a predetermined color.

8. The computer-implemented method of claim 6, wherein the visually distinguishing comprises removing, from display on the electronic data organizer, the at least one other event.

9. The computer-implemented method of claim 1, further comprising:
detecting, using the processor and within the data organizer application, a selection of a lens;
identifying, using the processor and based on a color scheme associated with the lens, a color associated with each of the events in the first layer; and
applying, using the processor and in the electronic data organizer, the color to each of the events in the first layer.

10. The computer-implemented method of claim 1, further comprising:
receiving, in a search panel associated with the data organizer application, at least one search criteria;
identifying, using the processor and from the events in the first layer and the events in the second layer, at least one event that matches the at least one search criteria;
receiving, from the user, a tag designation; and
applying the tag designation to the at least one event.

11. A computer system for managing an event on a data organizer application, the computer system comprising:
at least one processor;
at least one memory storing instructions that are executable by the at least one processor, wherein the instructions cause the at least one processor to:
detect a new event associated with an electronic data organizer of a user;
present, on the data organizer application, a control menu associated with the event, the control menu comprising an event attendance toggle;
receive, from the user, input directed to the event attendance toggle;
assign, based on the received input, the event to a first layer or a second layer of the electronic data organizer, wherein events in the first layer are positioned in front of events in the second layer;
designate, based on the received input, an availability state of the user for a duration of the event, wherein the availability state corresponds to an available state or an unavailable state;
display, on the electronic data organizer, the event in the first layer or the second layer based on the received input; and
broadcast the availability state of the user to at least one other user of the data organizer application.

12. The computer system of claim 11, wherein when the input corresponds to an attendance confirmation input, the assigning comprises:
assigning the event to the first layer and designate the availability state as the unavailable state.

13. The computer system of claim 11, wherein when the input corresponds to an attendance rejection input, the assigning comprises:
assigning the event to the second layer and designate the availability state as the available state.

14. The computer system of claim 11, wherein the instructions further cause the at least one processor to:
assign a tag to the event.

15. The computer system of claim 14, wherein to the assigning the tag comprises:
receiving, at a tag control bar of the data organizer application, a user selection of at least one target tag;
determining that the tag assigned to the event is associated with the at least one target tag; and
visually distinguishing the event in the electronic data organizer from at least one other event displayed on the electronic data organizer that is not assigned the tag.

16. The computer system of claim 15, wherein the visually distinguishing comprises representing the event with a predetermined color.

17. The computer system of claim 15, wherein the visually distinguishing comprises removing, from display on the electronic data organizer, the at least one other event.

18. The computer system of claim 11, wherein the instructions further cause the at least one processor to:
detect, within the data organizer application, a selection of a lens;
identify, based on a color scheme associated with the lens, a color associated with each of the events in the first layer; and
apply, in the electronic data organizer, the color to each of the events in the first layer.

19. The computer system of claim 11, wherein the instructions further cause the at least one processor to:
receive, in a search panel associated with the data organizer application, at least one search criteria;
identify, from the events in the first layer and the events in the second layer, at least one event that matches the at least one search criteria;
receive, from the user, a tag designation; and
apply the tag designation to the at least one event

20. A non-transitory computer-readable medium storing instructions for managing an event on a data organizer application, the instructions, when executed by at least one processor, causing the at least one processor to perform operations comprising:
detecting an event associated with an electronic data organizer of a user;
presenting, on the data organizer application, a control menu associated with the event, the control menu comprising an event attendance toggle;
receiving, from the user, input directed to the event attendance toggle;
assigning, based on the received input, the event to a first layer or a second layer of the electronic data organizer, wherein events in the first layer are positioned in front of events in the second layer;
designating, based on the received input, an availability state of the user for a duration of the event, wherein the availability state corresponds to an available state or an unavailable state;
displaying, on the electronic data organizer, the event in the first layer or the second layer based on the received input; and
broadcasting the availability state of the user to at least one other user of the data organizer application.
